(19) United States
(12) Patent Application Publication
(10) Pub. No.: US 2017/0332657 A1
(43) Pub. Date: Nov. 23, 2017

(54) METHOD OF MAKING AND PACKAGING A CAKE MIX DESSERT

(71) Applicant: Michelle F. Shields, Lyman, ME (US)

(72) Inventor: Michelle F. Shields, Lyman, ME (US)

(21) Appl. No.: 15/672,548

(22) Filed: Aug. 9, 2017

Related U.S. Application Data
(63) Continuation of application No. 14/669,239, filed on Mar. 26, 2015.
(60) Provisional application No. 61/971,125, filed on Mar. 27, 2014.

(51) Int. Cl. A23G 7/00; A23G 1/32

(52) U.S. Cl. CPC A23G 7/0062; A23G 1/32; A23V 2002/00

(57) ABSTRACT

A method of producing, packaging, and sealing of a prepared food dessert which includes a combination of a brownie mix and a chocolate cake mix to produce a dry mixture. The dry mixture is put into a mason jar or ripple cup and an infusion flavor (candy or chocolate) is added to the mix to obtain a molten lava center after heating. The packaging may comprise a gift cello wrap and/or a heat shrink seal. A spoon may be added to the packaging. The consumer adds water and microwaves the product for a ready to eat dessert.

This is a Nonprovisional patent application claiming priority of Provisional application for Patent No. 61/971,125, filed Mar. 27, 2014, the complete subject matter of which is incorporated herein by reference in its entirety.

### BACKGROUND OF THE INVENTION

### Field of the Invention

This invention relates generally to prepared food mixes and in particular to preparing and packaging a food dessert that is baked using microwave radiant energy.

### Description of Related Art

In the prior art U.S. Pat. No. 4,396,635 issued Aug. 2, 1983 to Richard Roudebush et al. discloses a culinary mix for preparing microwaved baked goods having various basic ingredients. However, it does not disclose a dessert cake mix made primarily of chocolate cake mix and brownie mix and having a molten candy center after heating.

U.S. Pat. No. 4,515,824 issued May 7, 1985 to Jon R. Blake et al. discloses granulated dry mixes for cakes characterized by the physical features of (1) particle size, (2) bulk porosity, (3) density, and (4) initial rates of moisture absorption. It does not disclose a dessert cake mix of chocolate cake mix and brownie mix and a molten candy center after heating.

U.S. Pat. No. 4,707,365 issued Nov. 17, 1987 to Louis V. Haynes et al. discloses a chocolate flavor system useful in formulating chocolate chip and other chocolate flavor products for baked goods especially chocolate chip cookies comprising a crumb-continuous matric and a plurality of chocolate flavored chips associated with the crumb-continuous mix.

U.S. Pat. No. 4,857,353 issued Aug. 15, 1989 to Glenn M. Jackson et al. discloses a dry culinary mix employing high levels of defined nucleating agents. The dry mixes enable the consumer to bake a cake using microwave radiant energy comparable to a conventionally oven baked cake in quality, structure, volume, and texture.

### SUMMARY OF THE INVENTION

Accordingly, it is therefore an object of this invention to provide a dessert cake mix that is fast and easy to prepare and delicious to taste.

It is a further object of this invention to provide a Jarva™ cake dessert with a molten lava center by inserting a piece of candy as a center ingredient into the middle of the cake prior to heating or cooking of the Jarva™ cake dessert.

It is another object of this invention to provide unique packaging that is attractive and very functional by being able to mix, cook and eat out the same packaging.

These and other objects are further accomplished by a method of making a dessert cake mix comprising the steps of providing a predetermined amount of brownie mix comprising about 55% by weight of the dessert cake mix, providing a predetermined amount of chocolate cake mix comprising about 45% by weight of the dessert cake mix, mixing the 55% by weight of brownie mix with the 45% by weight of chocolate cake mix to produce a batch of the dessert cake mix. The method comprises the step of providing a piece of candy for insertion into the dessert cake mix prior to heating of the dessert cake mix to produce a molten lava candy center after heating. The method further comprises the step of measuring approximately a ⅓ cup of the dessert cake mix and placing it into a ripple cup along with an approximately 0.05 oz. piece of meltable candy, and providing instructions for cooking including adding 2 tablespoons of water, blending well the water and dessert cake mix, and placing the candy in the center of the cup before cooking the dessert cake mix. The step of measuring approximately a ⅓ cup of the dessert cake mix and placing it into a ripple cup comprises the step of using a 8 oz. ripple cup. The method comprises the step of placing the ⅓ cup with the dessert cake mix and the candy into a microwave heating oven for a predetermined time to cook the cake mix and produce a candy molten lava center. The method comprises the steps of placing a spoon across a cover placed on the ripple cup, placing a shrink band across the cover portion of the ripple cup and under a bottom portion of the ripple cup, and heat shrinking the band around the ripple cup, thereby making the ripple cup tamperproof.

The method further comprises the step of measuring approximately a ¼ cup of the dessert cake mix and placing it into a mason jar along with a wrapped approximately piece of meltable candy, and providing instructions for cooking including adding 5 teaspoons of water, mixing well, unwrapping the candy and pressing the candy into the center of the mixed dessert cake mix prior to providing microwave heat for approximately 45 seconds to cook the dessert cake mix. The method further comprises the steps of wrapping the candy in a food safe wrap prior to cooking and attaching the wrapped candy to an inside portion of the mason jar cover, placing the cover on the mason jar, placing a spoon vertically along a side of the mason jar, placing a shrink band around a side of the cover, the spoon and a portion of the jar, and heat shrinking the shrink band around a side of the cover, the spoon and a portion of the jar thereby making the mason jar tamperproof.

The objects are further accomplished by providing a dessert cake mix, which comprises a brownie mix comprising about 55% by weight of the dessert cake mix, a chocolate cake mix comprising about 45% by weight of the dessert cake mix, the chocolate cake being combined with the brownie mix to form a batch of the dessert cake mix, and a piece of candy that melts when heated is added to each portion of the dessert cake mix separated from the batch. The piece of candy comprises a chocolate ball or square or a caramel square. A preferred batch of the cake mix comprises about six (6) pounds of the brownie mix combined with about five (5) pounds of the chocolate cake mix to produce about an eleven (11) pound batch of the dessert cake mix.

Additional objects, features and advantages of the invention will become apparent to those skilled in the art upon consideration of the following detailed description of the illustrated embodiment exemplifying the best mode of carrying out the invention as presently perceived.

### BRIEF DESCRIPTION OF THE DRAWINGS

The claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a flow chart of a method of making a Jarva™ cake mix dessert and packaging it in a ripple cup or a mason jar.

FIG. 2 is a perspective view of a ripple cup within a shrink wrap bag, having a spoon positioned on top of a cover, containing a Jarva™ cake mix dessert.

FIG. 3 is a side elevational view of a ripple cup with cover removed.

FIG. 4 is a bottom view of a ripple cup with instructions for preparing the Jarva™ cake mix for microwave heating.

FIG. 5 is a top view of a Jarva™ cake mix with a flavored candy in a ripple cup prior to adding a cover.

FIG. 6 is a perspective view of a mason jar containing a Jarva™ cake mix and having a spoon attached to a side of the mason jar.

FIG. 7 is a side elevational view of the mason jar containing the Jarva™ cake mix.

FIG. 8 is a top view of the mason jar containing a Jarva™ cake mix with spoon attached to a side of the jar.

FIG. 9 is a front perspective view of a food safe cello bag having enclosed therein a Jarva™ cake mix mason jar positioned within a stabilizing insert.

### DESCRIPTION OF THE PREFERRED EMBODIMENT

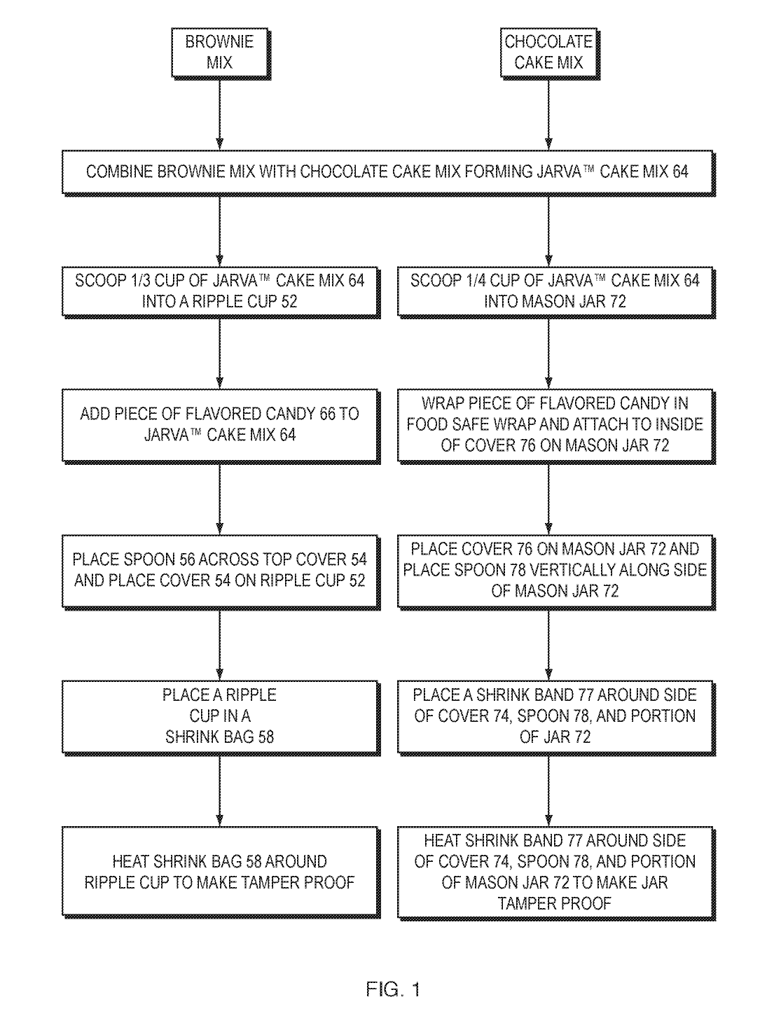

Referring to FIG. 1, a flow chart 10 shows a method or process 10 of making and packaging a Jarva™ cake mix dessert in a ripple cup package 50 or in a mason jar package 70. (JARVA™ is a trademark of Michelle Shields DBA JARVA™ Cakes of Lyman, Me.). The Jarva™ cake mix is a dessert that is fast and easy to cook and delicious to one's taste with unique packaging of the product. The customer of the Jarva™ cake only adds teaspoons of water and cooks the cake mix dessert in a microwave oven for less than one minute. A spoon 56,78 is provided with each package 50,70 for mixing prior to heating and for eating the dessert after heating.

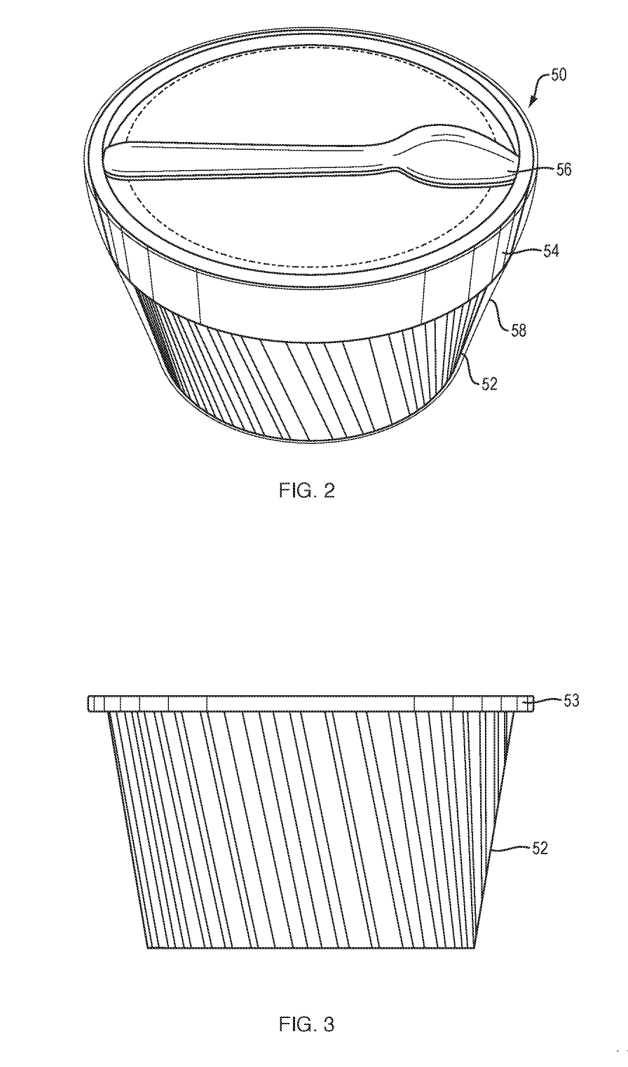

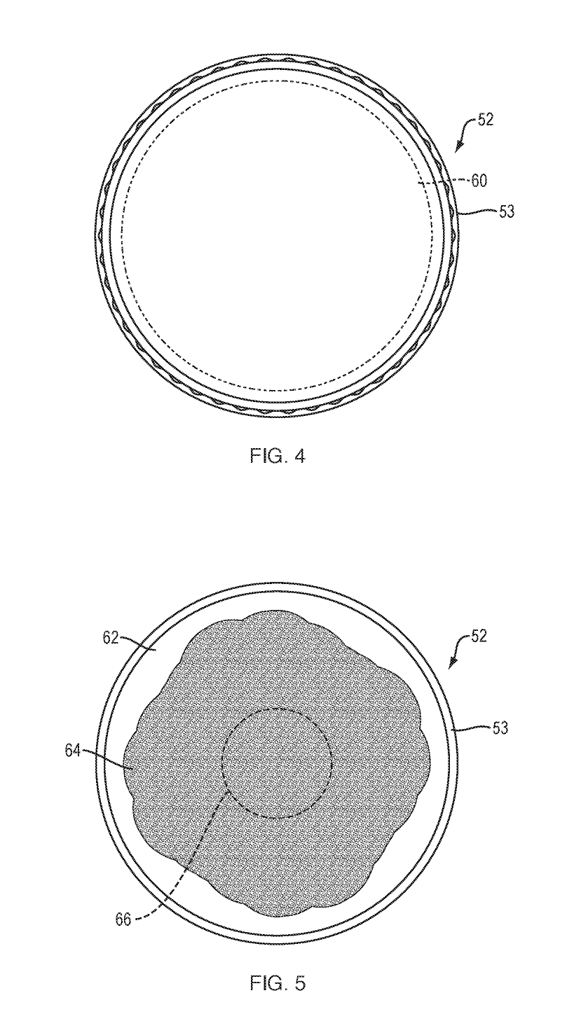

Referring to FIGS. 2 to 4, FIG. 2 is a perspective view of the ripple cup 52 within a shrink wrap bag, having a spoon 56 positioned on top of a cover 54, containing a Jarva™ cake mix 64. FIG. 3 is a side elevational view of the ripple cup 52 with the cover 54 removed. FIG. 4 shows a bottom view 60 of the ripple cup 42 and shows instructions provided on the bottom of the cup 42 for preparing the Jarva™ cake mix 64 for microwave heating.

Referring to FIG. 5, a top view of a ripple cup 42 is shown containing 8 oz. of the Jarva™ cake mix 64 with a flavored candy 66 in the center of the mix 64. The candy 66 is inserted into the center of the cake mix 64 as a center ingredient to provide a molten lava center when heated. This step of inserting the candy 66 is not just an ingredient to enhance flavor, but it is the unique step that achieves the candy molten lava center in the Jarva™ cake dessert that is made faster than a traditional recipe of a lava cake.

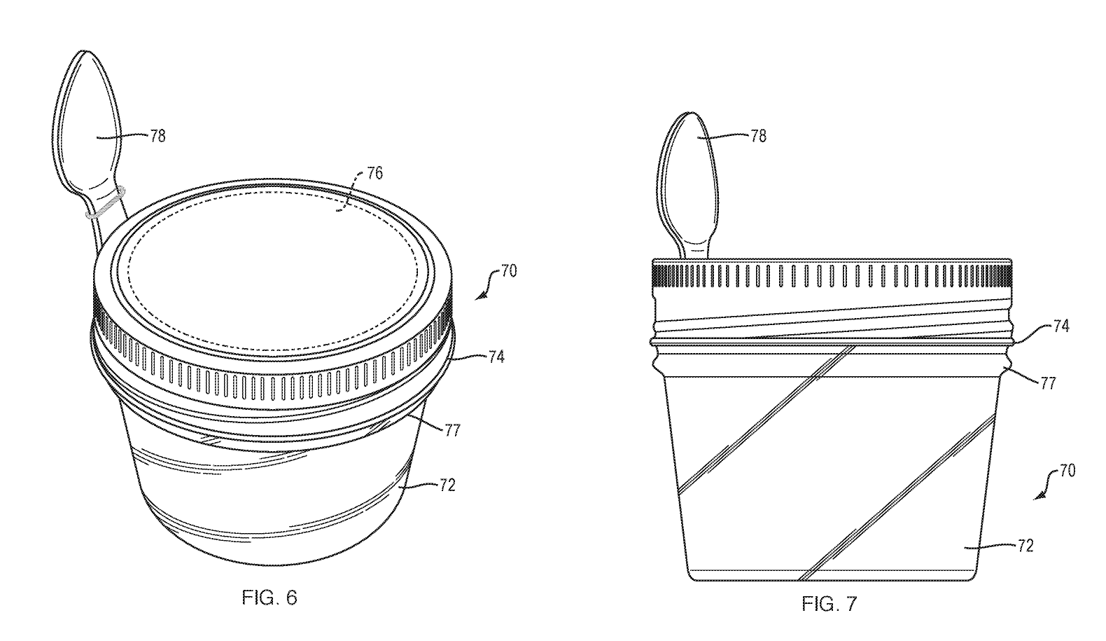

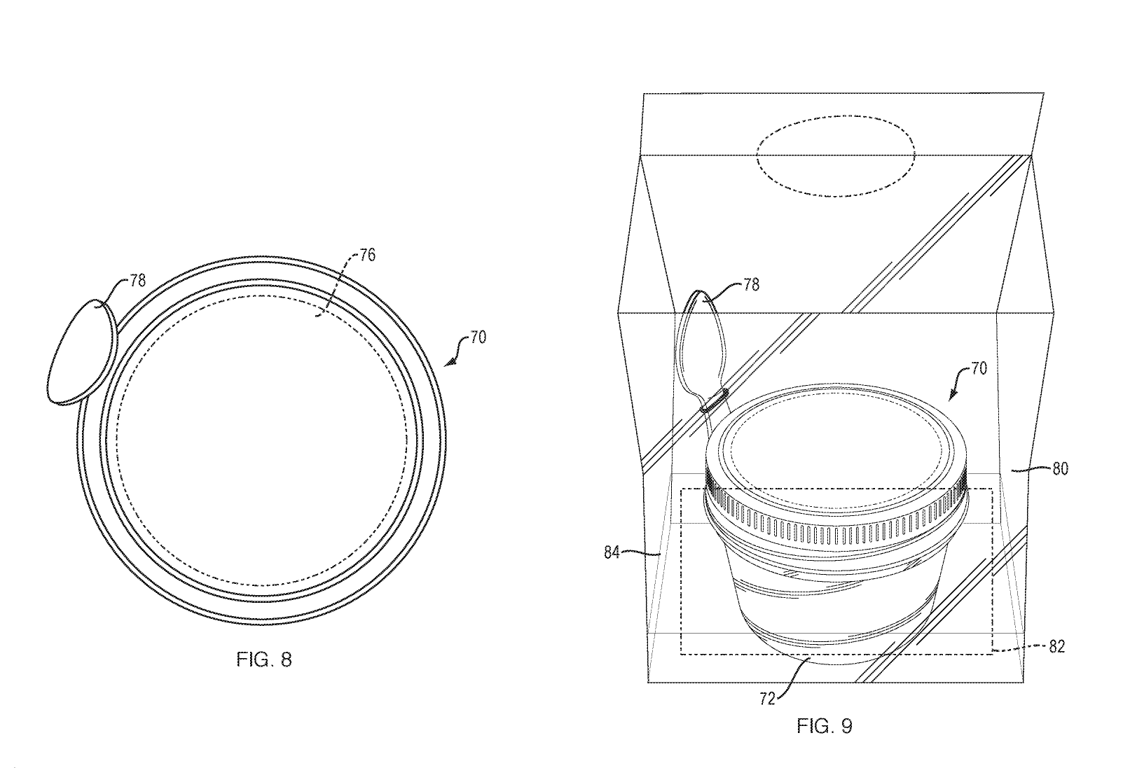

Referring now to FIGS. 6 to 8, FIG. 6 is a perspective view a Jarva™ cake mix 64 packaged in a mason jar 72 having a cover 74, a spoon 78 and shrink band 77 around the outer perimeter of the cover 74. A portion of the shrink band 77 extends over the side of the cover 74 to cover a portion of the sides of the mason jar 72, thereby making the Jarva™ cake package 70 to be tamperproof. The cover top 76 provides identification words for the mason jar Jarva™ cake packaging 70. FIG. 7 shows a side elevational view of the mason jar 72 containing the Jarva™ cake mix 64 along with a flavored candy 66 as shown in FIG. 5 except that the candy is wrapped and attached under the cover. FIG. 8 shows a mason jar top view 76 of the Jarva™ cake mix package 70 with the spoon 78 positioned on the side of the mason jar 72.

Referring again to FIG. 1, the flow chart 10 shows the steps of the method or process 10 for making and packaging the Jarva™ cake mix dessert in a ripple cup package 50 or a mason jar package 70. The mason jar package 70 is primarily used for special occasions such as weddings.

In Step 12 a brownie mix weighing approximately six (6) pounds is provided and the brownie mix may be embodied by a well-known Gold Metal Chocolate brownie mix manufactured by General Mills, of Minneapolis, Minn.

In Step 14 a chocolate cake mix weighing approximately five (5) pounds is provided and the chocolate cake mix may be embodied by a well-known Devils Food chocolate cake mix manufactured by General Mills of Minneapolis, Minn.

In Step 16 the brownie mix and chocolate cake mix are mixed together to form a Jarva™ cake mix 64. Each Jarva™ cake mix 64 is made preferably in approximately eleven (11) pound batches.

In Step 18 a ⅓ cup of the Jarva™ cake mix 64 is placed into a 8 oz. ripple cup 52 (see FIG. 2 and FIG. 5). The ripple cup 52 may be embodied by one manufactured by Pakright of Aberdeen, Id. The quantity of Jarva™ cake mix 64 of the approximately eleven (11) pound batch when used only for 8 oz. ripple cups 52 is sufficient to yield approximately 90-8 oz. ripple cups 52 (see FIG. 5).

In Step 20 a piece of flavored candy 66 weighing approximately 0.05 oz. is added to the ripple cup 52 within the Jarva™ cake mix 64 (FIG. 5). The candy 66 may be a chocolate ball or square or a caramel square or other flavor infused candy that may be popular with customers of the Jarva™ cake mix 64. The candy 66 provides a melted molten center for the Jarva™ cake mix dessert when heated in a microwave oven. However, prior to such heating, if a customer is ready to eat the Jarva™ cake mix dessert, two (2) tablespoons of water are added to the Jarva™ cake mix 66 and blended well in the ripple cup 52 and then the candy 66 is pressed into the center of the blended cake mix 64.

In Step 22, a cover 54 is placed on the ripple cup 52 and a spoon 56, which may be wooden or plastic, is placed across the top cover 54, each end of the spoon 56 being pressed within the outer rim of the cover 54.

In Step 24 the ripple cup cover 54 including the spoon 56 is placed in a shrink bag 58. The spoon 56 is kept clean because the shrink bag 58 covers it. The shrink wrap bag 58 may be obtained from Uline of Pleasant Prairie, Wis.

In Step 26 a heat gun is aimed at the bag 58 and the heat shrink bag 58 shrinks around the total ripple cup 50 to make it tamperproof (see FIG. 2).

In Step 30 a ¼ cup of Jarva™ cake mix 64 is placed in a 4 oz. mason jar 72 shown in FIG. 6. The ball mason jar 72 may be obtained from AG American Grocers. The quantity of the Jarva™ cake mix 64 of the approximately eleven (11) pound batch in Step 16 when used only for 4 oz. mason jars 72 is sufficient to yield approximately 109 4 oz. mason jars.

In Step 32, a 0.05 oz. piece of flavored candy 66 is wrapped in a food safe wrap such as commonly available cello wrap. The wrapped candy 66 is attached to the inside of the top cover 76 of the mason jar package 70. The candy 66 may be a chocolate ball or square or a caramel square or other flavor infused candy that may be popular with customers of the Jarva™ cake jar package 70. When the customer is ready to prepare the Jarva™ cake mix 64, five (5) teaspoons of water are added to the mason jar 72, the cake mix 64 and water are mixed for cooking, and then the candy 66 is unwrapped and sunk in the center of the cake mix 64 prior to microwave heating.

In Step 34, a cover 74 is attached to the mason jar 72 and a spoon 78, with or without a string decoration attached to the spoon 78, is placed vertically along the side of jar 70. The spoon 78 may be wooden or plastic.

In Step 36, a shrink band 77 is placed around the side of cover 74, spoon 78 and a portion of the jar 72 adjacent to the lower edge of cover 74. The spoon 78 stands vertical or upright adjacent to the jar 72. Instead of the shrink wrap band, a full enclosed shrink wrap sleeve may be used such as the shrink sleeve made by Uline of Pleasant Prairie, Wis.

In Step 38, a heat gun is aimed at the shrink band 77 around the side of the cover 74, spoon 78 and the portion of the mason jar 72 adjacent to the lower edge of cover 74, which causes the shrink wrap to shrink and make the total mason jar package 70 tamperproof.

Referring now to FIG. 9 the mason jar package 70 is placed in a food safe cello bag 80 which has a stabilizing one (1) inch high by four (4) inch square insert 84 with a center cutout for receiving the lower portion of the jar 72 with spoon 78 attached. The cello bag 80 is sealed at the top and keeps the spoon 78 clean. Also, the cello bag 80 has a sticker 82 applied to the outside of the cello bag with information regarding the ingredients and directions for use. The cello bag 50 with insert may be obtained from www.clearbags.com of Selmer, Tenn.

This invention has been disclosed in terms of a particular embodiment. It will be apparent that many modifications can be made to the disclosed method and packaging without departing from the invention. Therefore, it is the intent of the appended claims to cover all such variations as come with the true spirit and scope of this invention.

1-16. (canceled)

17. A method for preparing a desert package, comprising:
providing a predetermined amount of brownie mix;
providing a predetermined amount of chocolate cake mix;
mixing said brownie mix and said chocolate cake mix together to produce a dessert cake mix, wherein said dessert cake mix comprises about 55% by weight of said brownie mix and about 45% by weight of said chocolate cake mix;
placing a predetermined amount of said dessert cake mix into a container;
placing an edible candy in the center of said dessert cake mix, said candy to be used to produce a candy molten lava center after heating and cooking said dessert cake mix; and
placing said cover on top of said container to keep said dessert cake mix and said wrapped candy within an enclosed space defined by said container and said cover.

18. The method as recited in claim 17 further comprising:
opening the cover placed on top of said container;
adding a predetermined amount of water into said container containing said dessert cake mix;
blending said water and said dessert cake mix, with said candy in the mixture of said water and said dessert cake mix.

19. The method as recited in claim 17 wherein placing said predetermined amount of said dessert cake mix into said container comprises measuring approximately a ⅓ cup of said dessert cake mix.

20. The method as recited in claim 17 wherein said container comprises a ripple cup.

21. The method as recited in claim 18, further comprising:
heating said mixture of said water and said dessert cake mix having said candy provided therein by placing said container into a microwave heating oven for a predetermined time to cook said desert cake mix and produce a candy molten lava center.

22. The method as recited in claim 17, further comprising:
placing a spoon across said cover placed on said container;
placing said container including said cover and said spoon in a shrink bag; and
heat shrinking said bag around said container, thereby making said container tamperproof.

23. The method as recited in claim 17, wherein placing said predetermined amount of said dessert cake mix into said container comprises measuring approximately a ¼ cup of said dessert cake mix and placing said % cup of said dessert cake mix into a mason jar.

24. The method as recited in claim 23, wherein placing said ¼ cup of said dessert cake mix into said mason jar comprises placing said % cup of said dessert cake mix into a 4 oz. mason jar.

25. The method as recited in claim 23, further comprising adding 5 teaspoons of water into said mason jar, mixing said water and said dessert cake mix with said candy in the mixture of said water and said mixed dessert cake mix, and heating said mixture of said water and said dessert cake mix including said candy by placing said mason jar into a microwave heating oven for approximately 45 seconds to cook said dessert cake mix and produce a candy molten lava center.

26. A dessert package comprising:
a predetermined amount of a dessert cake mix comprising:
a brownie mix and a chocolate cake mix, said chocolate cake mix being combined with said brownie mix to form said dessert cake mix, wherein said dessert cake mix comprises about 55% by weight of said brownie mix and about 45% by weight of said chocolate cake mix;
a container containing said dessert cake mix;
an edible candy in said dessert cake mix, said candy to be used to produce a candy molten lava center after heating and cooking said dessert cake mix; and
a cover being placed on top of said container to keep said dessert cake mix and said candy within an enclosed space defined by said container and said cover.

27. The dessert package as recited in claim 26, wherein said candy comprises a chocolate ball or square or a caramel square.

28. The dessert package as recited in claim 26, wherein said predetermined amount of said dessert cake mix is separated from an eleven (11) pound batch of said dessert cake mix, which comprises about six (6) pounds of said brownie mix combined with about five (5) pounds of said chocolate cake mix.

29. The dessert package as recited in claim 26, wherein:
said container comprises a ripple cup;
approximately a ⅓ cup of said dessert cake mix is placed in said ripple cup;
a spoon is placed across said cover; and
said ripple cup is placed in a shrink wrapped bag.

30. The dessert package as recited in claim 26, wherein:
said container comprises a mason jar;
approximately a ¼ cup of said dessert cake mix is placed in a mason jar;
a spoon is placed vertically along a side of said mason jar; and
a shrink wrap band is placed around a side of said cover, said spoon, and a portion of said mason jar prior to applying heat to said shrink wrap band, to make said mason jar tamperproof.

31. The dessert package as recited in claim 30, wherein said mason jar with said dessert cake mix inside is placed in a cello bag via a cut-out which is subsequently sealed.
